(19) United States
(12) Patent Application Publication
(10) Pub. No.: US 2024/0320510 A1
(43) Pub. Date: Sep. 26, 2024

(54) METHODS AND APPARATUS FOR SENSITIVITY-BASED FINE TUNING OF A MACHINE LEARNING MODEL

(71) Applicants: Souvik Kundu, Los Angeles, CA (US); Sharath Nittur Sridhar, San Diego, CA (US); Sairam Sundaresan, San Diego, CA (US)

(72) Inventors: Souvik Kundu, Los Angeles, CA (US); Sharath Nittur Sridhar, San Diego, CA (US); Sairam Sundaresan, San Diego, CA (US)

(21) Appl. No.: 18/680,757

(22) Filed: May 31, 2024

(51) Int. Cl. G06N 3/096

(52) U.S. Cl. CPC G06N 3/096

(57) ABSTRACT

Systems, apparatus, articles of manufacture, and methods for sensitivity-based fine-tuning of a machine learning model are disclosed. Example instructions cause at least one processor circuit to perform a sensitivity analysis of a foundational model to identify sensitivity scores of respective layers of the foundational model, trim an intermediate layer of the foundational model based on the respective sensitivity score, and fine-tune the trimmed foundational model to create a fine-tuned model, the fine-tuning applied to layers having a respective sensitivity score that meets a threshold sensitivity.

### BACKGROUND

Machine learning models, such as large language models (LLMs), have been extremely successful on many non-trivial natural language processing (NLP) tasks like question answering, text classification. Recently, the advent of generative pre-trained models (GPT) and various other large language models have further pushed the boundary of applications with pre-trained language models, ranging from Artificial Intelligence (AI) for science to code generation. These models are generally pre-trained on a large unlabeled text corpus followed by fine-tuning on a task-specific data set to allow for performance of a corresponding task.

### BRIEF DESCRIPTION OF THE DRAWINGS

FIG. 1 is a block diagram of an example approach for sensitivity driven fine-tuning of a machine learning model.

FIG. 2 is a block diagram of an example implementation of sensitivity-based training circuitry to perform sensitivity-based fine-tuning of a machine learning model.

FIG. 3 is a flowchart representative of example machine readable instructions and/or example operations that may be executed, instantiated, and/or performed by example programmable circuitry to implement the sensitivity-based training circuitry of FIG. 2 to generate a fine-tuned model based on a foundational model.

FIG. 4 is a flowchart representative of example machine readable instructions and/or example operations that may be executed, instantiated, and/or performed by example programmable circuitry to implement the sensitivity-based training circuitry of FIG. 2 to generate a fine-tuned sub-models based on an elastic search space.

FIG. 5 is a block diagram representing the example trimming process of FIGS. 3 and/or 4.

FIG. 6 illustrates sensitivities of layers of a machine learning model.

FIG. 7 illustrates accuracy of resultant models based on varying training budgets.

FIG. 8 is a block diagram of an example processing platform including programmable circuitry structured to execute, instantiate, and/or perform the example machine readable instructions and/or perform the example operations of FIGS. 3 and/or 4 to implement the sensitivity-based training circuitry of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 3 and/or 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A large language model (LLM) is an artificial intelligence model that can generate natural language text based on input prompts. An LLM uses machine learning techniques to analyze vast amounts of data, including texts written by humans, to learn patterns and structures in language.

To operate an LLM, a prompt (or question) is provided as an input to the LLM. The LLM operates on the input to generate an output. The generated output could be anything from a simple sentence, a complex paragraph, a whole document, or even outputs other than text (e.g., video, audio, etc.). The LLM's output is typically natural-sounding, making it useful for a wide range of applications such as language translation, chatbots, and content generation.

An LLM operates by processing the input prompt through multiple layers of neural networks that analyze the text and identify patterns and relationships between words and phrases. The model then generates new text based on these patterns, using probability distributions to determine which words or phrases are most likely to come next in a given sequence. This process is repeated many times, with each layer building upon the output of the previous one, until the LLM produces an output.

Recently, autoregressive generative models using retrieval augmentation have shown great promise in both text-to-image and image-to-text generation. These models primarily involve training an encoder-decoder or decoder only transformer architectures. LLMs have served as foundational models for various down-stream application tasks. However, such LLMs usually need further supervised fine-tuning (SFT) to perform well at specific tasks (e.g., text-to-image generation, image-to-text generation, etc.) in various domains. Such large-scale pre-training and fine-tuning of these models on billions of retrieval data and supervised training data limits their applications on limited-resource devices. Even in situations where computing resources are plentiful, a time-bound budgeted training/fine-tuning enables limits to be placed on carbon emissions associated with training of such generative and foundation AI models.

Existing solutions can be divided into two categories: resource-efficient fine-tuning, and resource-efficient inference or evaluation. For the first category, there are various solutions including pruning, low-rank approximation (LoRA), and adapter-based solutions. Pruning is an iterative approach. The irregular nature of pruning may yield a model that is not suitable to leverage compute or latency benefit in hardware. LoRA and other adapter-based approaches are a class of “efficient fine-tuning” solutions that only updates a small fraction of modules while keeping majority of the model parameters frozen to their pre-trained values. During inference, the full model is used along with the adapter.

In contrast to these solutions, for a given resource budget, examples disclosed herein utilize a model's layer sensitivity to fine-tune only a portion of model parameters, and use only these parameters during inference. Additionally, sensitivity driven efficient fine-tuning disclosed herein enables a neural architecture search (NAS) during fine-tuning to yield multiple subnetworks. In contrast to existing NAS solutions, examples disclosed herein utilize layer sensitivity to define a heterogeneous elastic search space for different model layers, and perform elastic fine-tuning of the model using the heterogenous search space, to yield benefits of generating multiple subnetworks while also taking the benefits of traditionally pretrained foundational models.

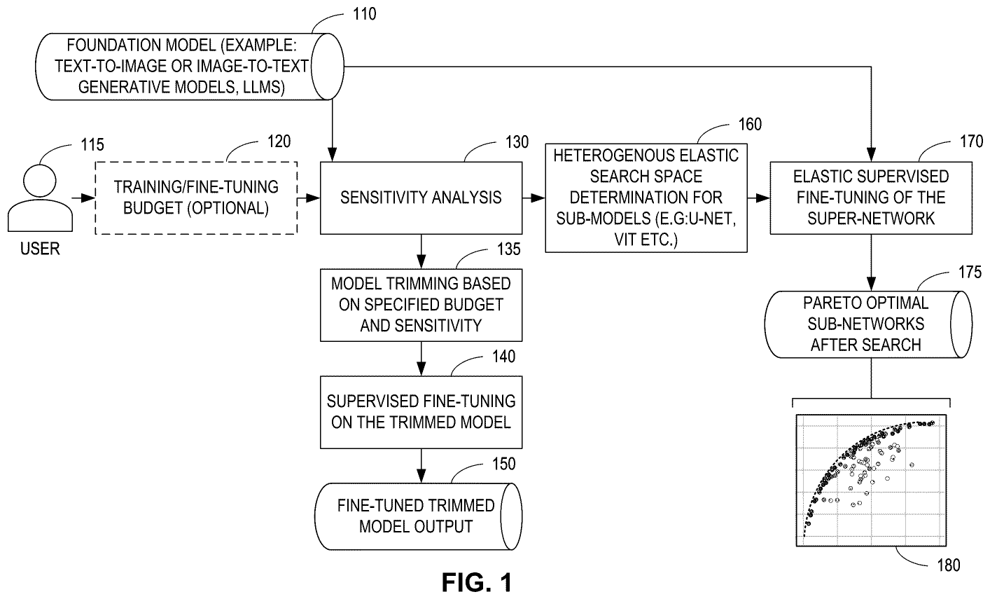

FIG. 1 is a block diagram of an example approach for sensitivity driven fine-tuning of a machine learning model. The example approach of FIG. 1 operates on a foundational model 110. A user 115 identifies a budget 120 for training and/or fine-tuning of the foundational model 110. In some examples, the budget may be pre-defined (e.g., a default budget). In some examples, the training and fine-tuning budget can be directly provided by the user 115 via proxies like a total training/fine-tuning FLOPs budget. In some examples, the user provides a prompt (e.g., textual instructions) that mentions a choice of a candidate super-network along with their choice of elastic parameter budget. This enables the model to elastically finetune according to the user-given elastic ranges.

For a given training or fine-tuning budget, the example approach of FIG. 1 involves a sensitivity analysis 130 of the model to understand the importance of the model layers including, heads, intermediate multi-layer perceptron (MLP) and attention dimensions, token size, etc. Model trimming 135 is then applied based on the budget and 120 and the identified sensitivity. The trimmed model is then fine-tuned 140 using supervised fine-tuning to produce a fine-tuned trimmed model 150.

In some examples, the model sensitivity identified by the sensitivity analysis 130 is used to define a heterogeneous elastic search space 160 of the model for generation of multiple sub-models for efficient inference while performing the supervised fine-tuning on the foundational model. Different types of search spaces might be utilized focused on different types of models and/or architectures. For example, search spaces specific to vision transformers (ViT), convolutional neural networks (e.g., U-Net), might be used. The elastic search space is used to perform supervised fine-tuning of the super-network 170 to produce one or more pareto-optimal sub-models 175. Such pareto-optimal sub-models may be represented in a pareto frontier representation 180, to enable a user to better understand variables like model accuracy, time efficiency, etc.

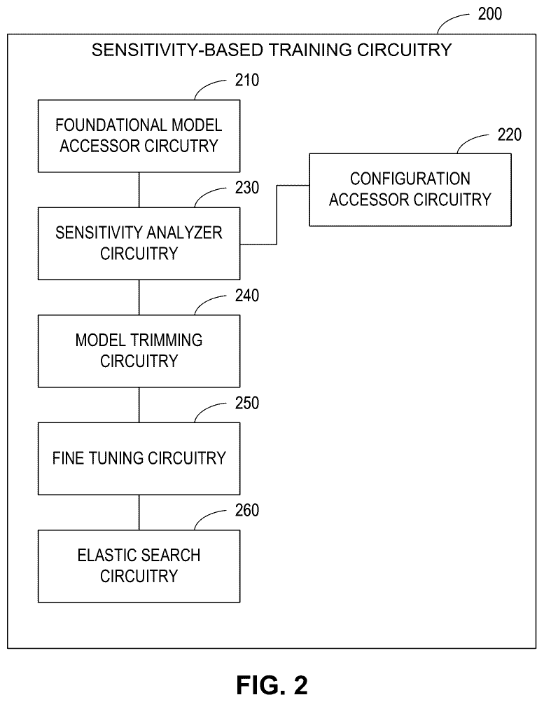

FIG. 2 is a block diagram of an example implementation of sensitivity-based training circuitry 200 to perform sensitivity-based fine-tuning of a foundational model. The sensitivity-based training circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the sensitivity-based training circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example sensitivity-based training circuitry 200 of the illustrated example of FIG. 2 includes foundational model accessor circuitry 210, configuration accessor circuitry 220, sensitivity analyzer circuitry 230, model trimming circuitry 240, fine-tuning circuitry 250, and elastic search circuitry 260.

The example foundational model accessor circuitry 210 of the illustrated example of FIG. 2 enables the sensitivity-based training circuitry 200 to access a foundational model from an external source or database (e.g., cloud storage). The foundational model serves as a starting point for further analysis and/or modification. In some examples, the foundational model is a Large Language Model (LLM). However, any other type of machine learning model may additionally or alternatively be used. The example foundational model accessor circuitry 210 accesses the foundational model from a database, file share, remote server, cloud location, etc. In some examples, the foundational model is provided directly (or indirectly) to the foundational model accessor circuitry 210.

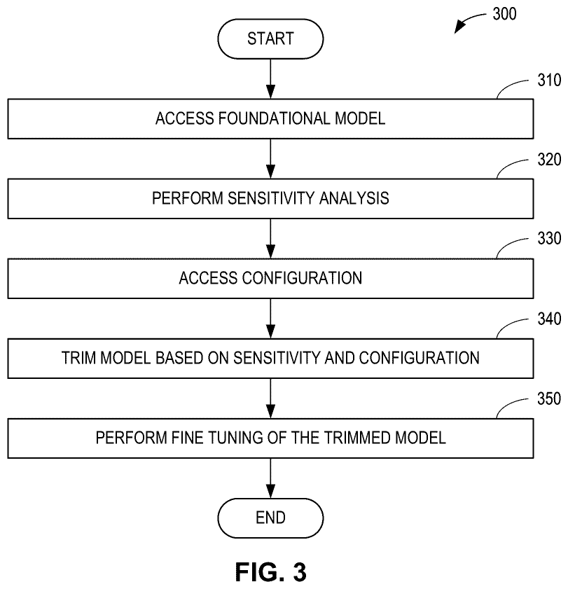

In some examples, the foundational model accessor circuitry 210 is instantiated by programmable circuitry executing foundational model accessor instructions and/or configured to perform operations such as those represented by the flowchart(s) of FIGS. 3 and/or 4.

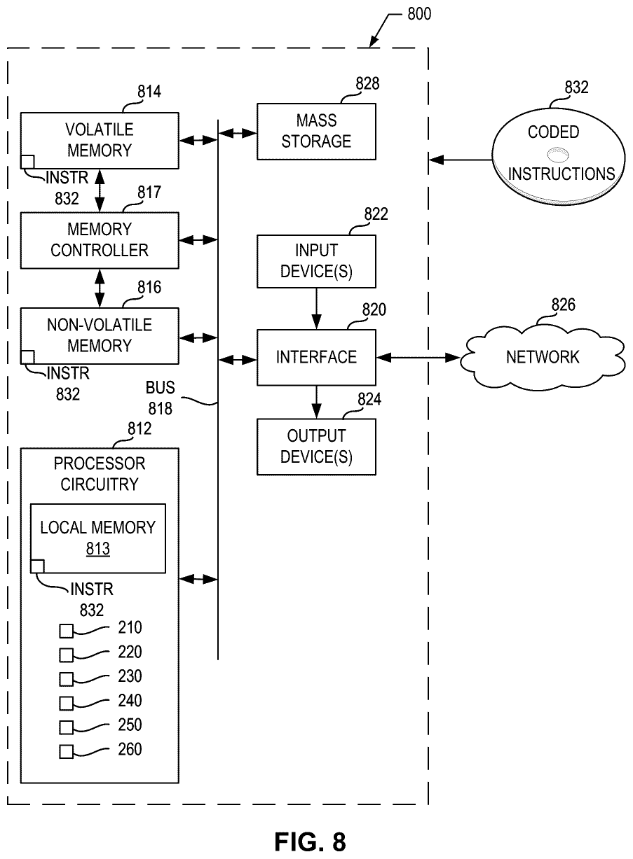

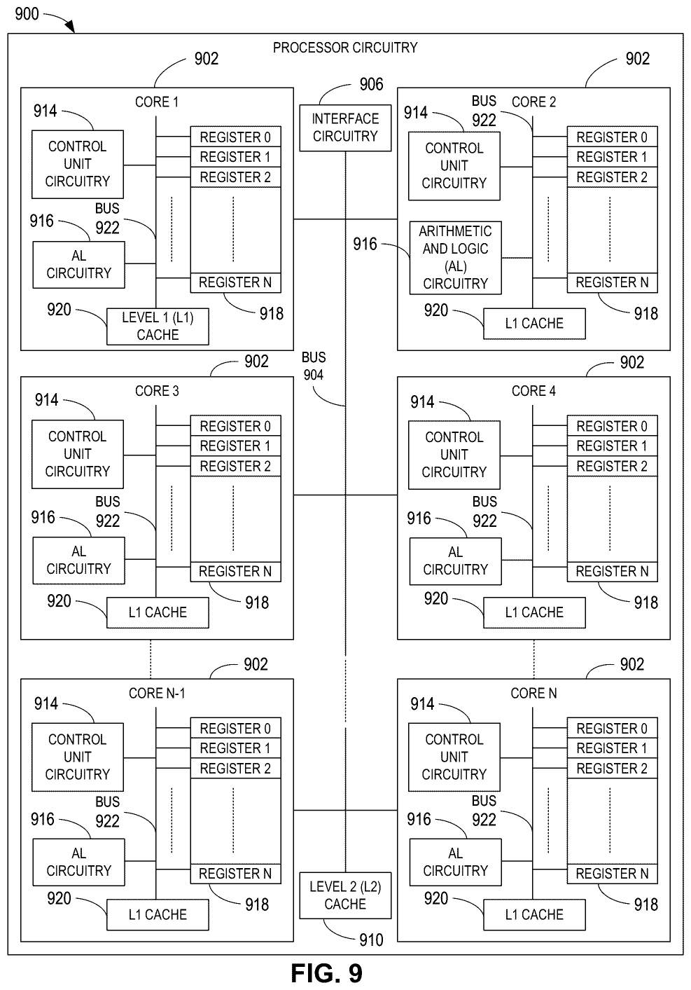

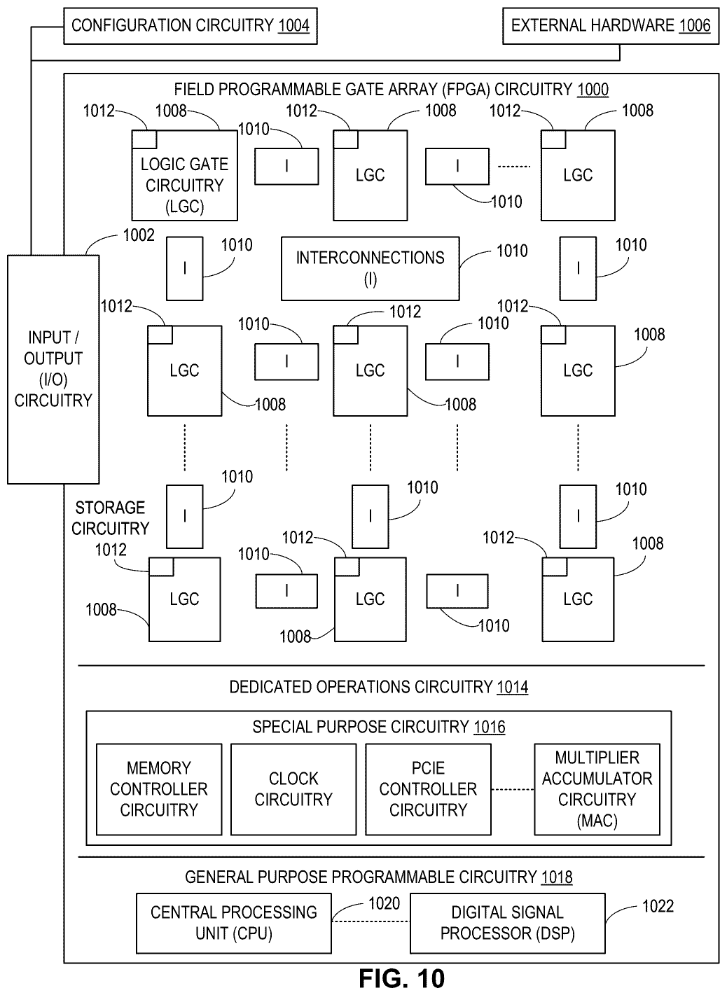

In some examples, the sensitivity-based training circuitry 200 includes means for accessing a foundational model. For example, the means for accessing a foundational model may be implemented by foundational model accessor circuitry 210. In some examples, the foundational model accessor circuitry 210 may be instantiated by programmable circuitry such as the example programmable circuitry 812 of FIG. 8. For instance, the foundational model accessor circuitry 210 may be instantiated by the example microprocessor 900 of FIG. 9 executing machine executable instructions such as those implemented by at least blocks 310, 410 of FIGS. 3 and/or 4. In some examples, the foundational model accessor circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the foundational model accessor circuitry 210 may be instantiated by any other combination of hardware, software, and/or firmware. For example, the foundational model accessor circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example configuration accessor circuitry 220 of the illustrated example of FIG. 2 accesses configuration information to be used during fine-tuning of the foundational model. (Block 430). The configuration information defines a budget (e.g., a compute budget) that is to be utilized in the fine-tuning process. In some examples, the budget may be pre-defined (e.g., a default budget). In some examples, the training and fine-tuning budget can be directly provided by the user 115 via proxies like a total training/fine-tuning FLOPs budget. In some examples, the user provides a prompt (e.g., textual instructions) that mentions a choice of a candidate super-network along with their choice of elastic parameter budget. This enables the model to elastically finetune according to the user-given elastic ranges.

In some examples, the configuration accessor circuitry 220 is instantiated by programmable circuitry executing configuration accessor instructions and/or configured to perform operations such as those represented by the flowchart(s) of FIGS. 3 and/or 4.

In some examples, the sensitivity-based training circuitry 200 includes means for accessing a configuration. For example, the means for accessing a configuration may be implemented by configuration accessor circuitry 220. In some examples, the configuration accessor circuitry 220 may be instantiated by programmable circuitry such as the example programmable circuitry 812 of FIG. 8. For instance, the configuration accessor circuitry 220 may be instantiated by the example microprocessor 900 of FIG. 9 executing machine executable instructions such as those implemented by at least blocks 330, 430 of FIGS. 3 and/or 4. In some examples, the configuration accessor circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the configuration accessor circuitry 220 may be instantiated by any other combination of hardware, software, and/or firmware. For example, the configuration accessor circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example sensitivity analyzer circuitry 230 of the illustrated example of FIG. 2 identifies sensitivities of various elements of the foundational model (e.g., a layer, a node, a block, etc.). As used herein, a sensitivity represents a quantification of how sensitive a particular element of a model is to various inputs. In other words, a sensitivity score represents a relative importance of an element (e.g., a layer, a node, a block, etc.) of a foundational model to an output of the foundational model. These identified sensitivities are later used in model trimming and/or training.

In some examples, the sensitivity analyzer circuitry 230 is instantiated by programmable circuitry executing sensitivity analyzer instructions and/or configured to perform operations such as those represented by the flowchart(s) of FIGS. 3 and/or 4.

In some examples, the sensitivity-based training circuitry 200 includes means identifying sensitivities of elements of a model. For example, the means for identifying sensitivities may be implemented by sensitivity analyzer circuitry 230. In some examples, the sensitivity analyzer circuitry 230 may be instantiated by programmable circuitry such as the example programmable circuitry 812 of FIG. 8. For instance, the sensitivity analyzer circuitry 230 may be instantiated by the example microprocessor 900 of FIG. 9 executing machine executable instructions such as those implemented by at least blocks 320, 420 of FIGS. 3 and/or 4. In some examples, the sensitivity analyzer circuitry 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the sensitivity analyzer circuitry 230 may be instantiated by any other combination of hardware, software, and/or firmware. For example, the sensitivity analyzer circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example model trimming circuitry 240 the illustrated example of FIG. 2 trims the foundational model based on the identified sensitivities and the configuration. This trimming produces a trimmed model. To trim the model, learned mask values are used to rank the intermediate layer tensors. With this sensitivity evaluation, the intermediate layer dimensions are trimmed for both multi-head self-attention (MHSA) and multilayer perceptron (MLP) by a certain fraction and yield proportional MACs and number of parameters reduction.

In some examples, the model trimming circuitry 240 is instantiated by programmable circuitry executing model trimming instructions and/or configured to perform operations such as those represented by the flowchart(s) of FIGS. 3 and/or 4.

In some examples, the sensitivity-based training circuitry 200 includes means for trimming. For example, the means for trimming may be implemented by model trimming circuitry 240. In some examples, the model trimming circuitry 240 may be instantiated by programmable circuitry such as the example programmable circuitry 812 of FIG. 8. For instance, the model trimming circuitry 240 may be instantiated by the example microprocessor 900 of FIG. 9 executing machine executable instructions such as those implemented by at least blocks 340, 450 of FIGS. 3 and/or 4. In some examples, the model trimming circuitry 240 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the model trimming circuitry 240 may be instantiated by any other combination of hardware, software, and/or firmware. For example, the model trimming circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example fine-tuning circuitry 250 the illustrated example of FIG. 2 performs fine tuning of the trimmed model. This fine-tuning produces a fine-tuned model. In examples disclosed herein, the fine-tuning is applied to layers of the model having a respective sensitivity score that meets a threshold sensitivity (e.g., as defined by the compute budget). In some examples, the threshold sensitivity is directly defined in the budget. However, in some examples, the threshold sensitivity is computed based on the budget. Such computation may be based on, for example, an amount of compute resources available at the sensitivity-based training circuitry 200.

In some examples, the fine-tuning circuitry 250 is instantiated by programmable circuitry executing fine-tuning instructions and/or configured to perform operations such as those represented by the flowchart(s) of FIGS. 3 and/or 4.

In some examples, the sensitivity-based training circuitry 200 includes means for fine-tuning. For example, the means for fine-tuning may be implemented by fine-tuning circuitry 250. In some examples, the fine-tuning circuitry 250 may be instantiated by programmable circuitry such as the example programmable circuitry 812 of FIG. 8. For instance, the fine-tuning circuitry 250 may be instantiated by the example microprocessor 900 of FIG. 9 executing machine executable instructions such as those implemented by at least blocks 350, 460 of FIGS. 3 and/or 4. In some examples, the fine-tuning circuitry 250 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the fine-tuning circuitry 250 may be instantiated by any other combination of hardware, software, and/or firmware. For example, the fine-tuning circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example elastic search circuitry 260 of the illustrated example of FIG. 2 determines an elastic search space to be used for searching for sub-models and implements a plurality of trimming and fine-tuning operations to accomplish sensitivity-based fine-tuning of the foundational model within the search space. This culminates in generation of a pareto-optimal representation of the results of the fine-tuning. This representation enables the user to better understand the varying parameters that may be used to create a sub-model, thereby informing the user of budget information that may be used in subsequent fine-tuning and/or elastic search.

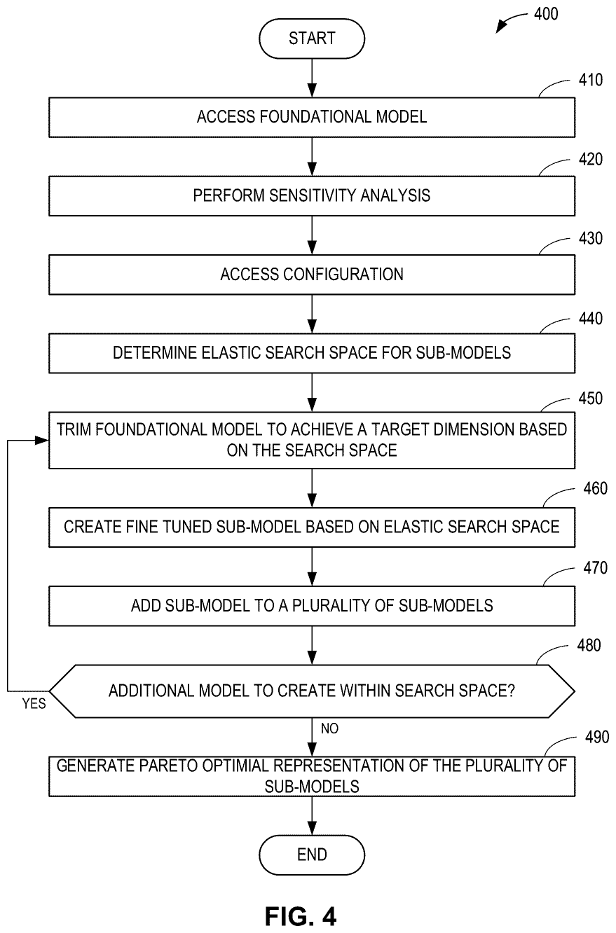

In some examples, the elastic search circuitry 260 is instantiated by programmable circuitry executing elastic search instructions and/or configured to perform operations such as those represented by the flowchart(s) of FIG. 4.

In some examples, the sensitivity-based training circuitry 200 includes means for searching. For example, the means for searching may be implemented by elastic search circuitry 260. In some examples, the elastic search circuitry 260 may be instantiated by programmable circuitry such as the example programmable circuitry 812 of FIG. 8. For instance, the elastic search circuitry 260 may be instantiated by the example microprocessor 900 of FIG. 9 executing machine executable instructions such as those implemented by at least blocks 440, 470, 480, 490 of FIG. 4. In some examples, the elastic search circuitry 260 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the elastic search circuitry 260 may be instantiated by any other combination of hardware, software, and/or firmware. For example, the elastic search circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the sensitivity-based training circuitry 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the example foundational model accessor circuitry 210, the example configuration accessor circuitry 220, the example sensitivity analyzer circuitry 230, the example model trimming circuitry 240, the example fine-tuning circuitry 250, the example elastic search circuitry 260, and/or, more generally, the example sensitivity-based training circuitry 200 of FIG. 2, may be implemented by hardware alone or by hardware in combination with software and/or firmware. Thus, for example, any of the example foundational model accessor circuitry 210, the example configuration accessor circuitry 220, the example sensitivity analyzer circuitry 230, the example model trimming circuitry 240, the example fine-tuning circuitry 250, the example elastic search circuitry 260, and/or, more generally, the example sensitivity-based training circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example sensitivity-based training circuitry 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the sensitivity-based training circuitry 200 of FIG. 2 and/or representative of example operations which may be performed by programmable circuitry to implement and/or instantiate the sensitivity-based training circuitry 200 of FIG. 2, are shown in FIGS. 3 and/or 4. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3 and/or 4, many other methods of implementing the example sensitivity-based training circuitry 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and/or 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations that may be executed, instantiated, and/or performed by example programmable circuitry to implement the sensitivity-based training circuitry 200 of FIG. 2 to generate a fine-tuned model based on a foundational model.

The example process 300 of FIG. 3 begins when the foundational model accessor circuitry 210 accesses a foundational model from an external source or database (e.g., cloud storage). (Block 310). The foundational model serves as a starting point for further analysis and/or modification. In some examples, the foundational model is a Large Language Model (LLM). However, any other type of machine learning model may additionally or alternatively be used. The example foundational model is accessed from a database, file share, remote server, cloud location, etc.

The example sensitivity analyzer circuitry 230 performs a sensitivity analysis of the foundational model. (Block 320). The sensitivity analysis identifies sensitivities of various elements of the foundational model (e.g., a layer, a node, a block, etc.). As used herein, a sensitivity represents a quantification of how sensitive a particular element of a model is to various inputs. In other words, a sensitivity score represents a relative importance of an element (e.g., a layer, a node, a block, etc.) of a foundational model to an output of the foundational model. These identified sensitivities are later used in model trimming and/or training.

Performing a sensitivity evaluation of a model may often be costly and iterative. The example sensitivity analysis disclosed herein presumes the use of a language model with L layers, each consisting of a multi-head self-attention (MHSA) block followed by a multi-layer perceptron (MLP) block, with each layer having H heads. However, other models may additionally or alternatively be used.

An MHSA block takes an input tensor X∈R^{(N×Din)} with sequence length and embedding dimension as N and Din, respectively. Each of the Query (Q), Key (K), and Value (V) linear transformation layers generates an intermediate tensor Tₘₕₛₐ∈R^{(N×Dffn)} which finally gets projected to the output tensor Oₘₕₛₐ∈R^{(N×Din)}.

For an MLP block, the intermediate tensor size is Tₘₗₚ∈R^{(N×Dffn)}, which acts as the output and input of a first and second fully connected (FC) layer, respectively, to finally produce output O_{ffn}∈R^{(N×Din)}. Thus, two intermediate tensor dimensions $D_{attn}$ and $D_{ffn}$ translate to the sensitivity analysis of the MHSA and MLP modules for each layer. A set of learnable (non-binary) mask values is identified as mask tensor m, for each of MHSA and MLP intermediate tensor mₘₕₛₐ∈R^{Dattn} and mₘₗₚ∈R^{Dffn}, respectively. The object of the sensitivity analysis is then defined using Equation 1, below:

$${min}_{{Θ}_{T} ( f ( X ) ) , m} {ℒ}_{CE} ( Φ ( m ⊙ {Θ}_{T} ( f ( X ) ) , y ) + {‖ m ‖}_{1} \qquad Equation 1$$

In Equation 1, the second term represents the L₁-regularizer of the mask tensor. In some examples, a single epoch of the above minimization objective may be used to provide learned mask tensor values, that can then be used to rank the importance of a layer after normalization. In some examples, the learned mask values to rank the intermediate layer tensors.

The configuration accessor circuitry 220 accesses configuration information to be used during fine-tuning of the foundational model. (Block 330). The configuration information defines a budget (e.g., a compute budget) that is to be utilized in the fine-tuning process.

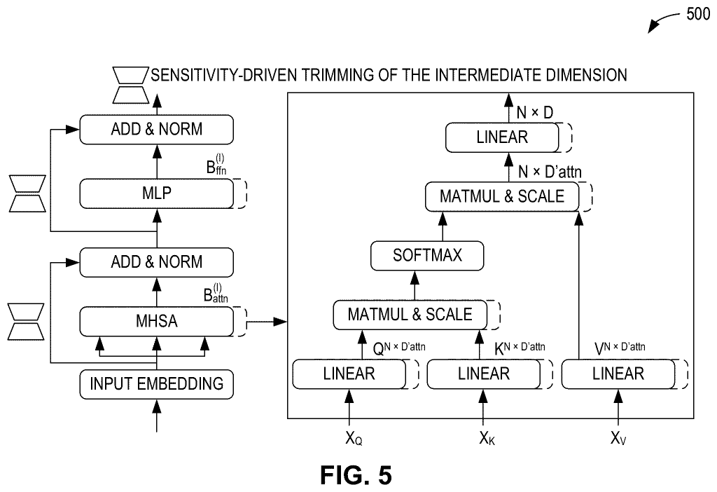

The example model trimming circuitry 240 then trims the foundational model based on the identified sensitivities and the configuration. (Block 340). This trimming produces a trimmed model. To trim the model, the learned mask values are used to rank the intermediate layer tensors. With this sensitivity evaluation, the intermediate layer dimensions are trimmed for both MHSA and MLP by a certain fraction and yield proportional MACs and number of parameters reduction. As shown in FIG. 5, below, for a layer 1, for MHSA, the intermediate dimensions after trimming can be given by D′attn, instead of the original Dattn, where D′attn<Dattn. Apart from the L1 regularization-based mask learning, other low-cost proxies may additionally or alternatively be used to evaluate the layer sensitivity, including Hessian or gradient driven direct sensitivity evaluation.

The example fine-tuning circuitry 250 then performs fine tuning of the trimmed model. (Block 350). This fine tuning produces a fine-tuned model. In examples disclosed herein, the fine-tuning is applied to layers of the model having a respective sensitivity score that meets a threshold sensitivity (e.g., as defined by the compute budget). In some examples, the threshold sensitivity is directly defined in the budget. However, in some examples, the threshold sensitivity is computed based on the budget. Such computation may be based on, for example, an amount of compute resources available at the sensitivity-based training circuitry 200.

With the sensitivity evaluation done via the proxy of L1-regularization, the fine-tuning circuitry 250 evaluates the tensors that are more important for a given resource and/or parameter budget. For example, for a parameter density d, the fine-tuning circuitry 250 evaluates the sensitivity against the threshold mask scaler value mₜₕ (i.e., the threshold sensitivity described above). Below the threshold, all the values in m can be made 0, and above the threshold the masks should have a value of one. This way, the example fine-tuning circuitry 250 binarizes the mask tensor after sensitivity evaluation, and uses the mask tensor for parameter efficient fine-tuning. Note that, during fine-tuning, the parameters associated with a zero mask value are not updated, and thus the MACs compute-cost can be avoided via zero gating logic in the processing elements. In some examples, this efficient fine-tuning needs the user to provide the budget d, to evaluate the threshold mask value. Thus, here the assumption is that the user has knowledge about the downstream hardware budget to provide d.

After fine tuning, the fine-tuned model may then be deployed for execution (e.g., inference). During inference, the model retains the same fraction of non-zero parameters to maintain the target density d, yielding similar compute benefits as fine-tuning.

FIG. 4 is a flowchart representative of example machine readable instructions and/or example operations that may be executed, instantiated, and/or performed by example programmable circuitry to implement the sensitivity-based training circuitry 200 of FIG. 2 to generate fine-tuned sub-models based on an elastic search space.

The example process 400 of FIG. 4 begins when the foundational model accessor circuitry 210 accesses a foundational model. (Block 410). In some examples, the foundational model is a Large Language Model (LLM). However, any other type of machine learning model may additionally or alternatively be used. The example foundational model is accessed from a database, file share, remote server, cloud location, etc. This model serves as a starting point for further analysis and/or modification.

The example sensitivity analyzer circuitry 230 evaluates the model to determine sensitivities of various layers. (Block 420). An example approach to performing a sensitivity analysis is described above in connection with block 320 of FIG. 3.

The configuration accessor circuitry 220 accesses configuration information to be used during fine-tuning of the foundational model. (Block 430). The configuration information defines a budget (e.g., a compute budget) that is to be utilized in the fine-tuning process.

The example elastic search circuitry 260 determines an elastic search space to be used for searching for sub-models. (Block 440). Often, a user may not have enough knowledge to provide a fixed budget, such as a parameter density. In that case, a neural architecture search (NAS) approach is useful, which can yield a list of sub-models able to meet requirements across various performance objectives such as, accuracy-latency, accuracy-model size, accuracy-cycles, etc.

To determine the elastic search space, the example elastic search circuitry 260 analyzes sensitivity values for each layer to normalize the value(s) and identify the important modules/layers. Once the important modules are identified, higher min and max values are issued as search space options for such tensor dimensions. For example, a max value may be identified as the max size of the dimension of the original super-net. While for a low importance module, instead of having same search values and ranges, lower min and max values are assigned. For example, the max values may be lower than the original supernet dimension value for a specific tensor.

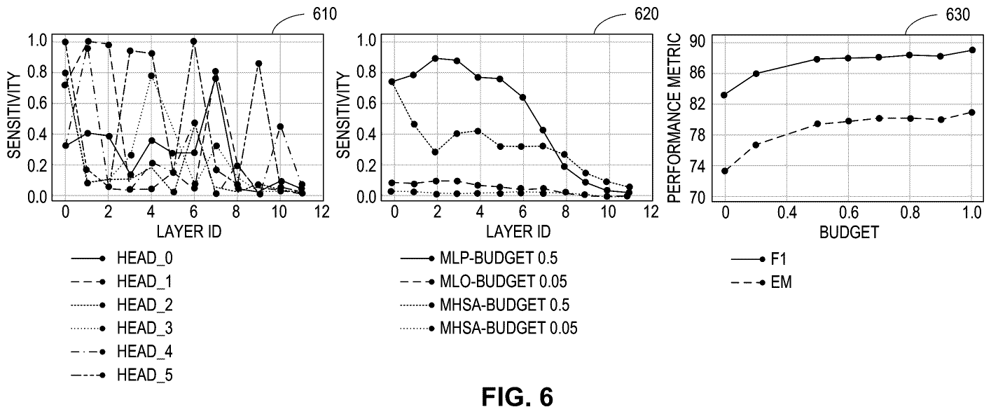

For example, as shown below in graph 620 of FIG. 6, the later MLP layers have lower sensitivity compared to that of the earlier ones. This sensitivity driven information is used to define the earlier layer intermediate MLP dimension search space values to be [1024, 2048, 3072], with 3072 being the dimension for the supernet intermediate MLP layer. For the later layers (e.g., the 10th, 11th, and/or 12th layer), the search space values may be defied as [512, 768, 1024] as the intermediate dimension. Through such heterogeneous definition of layer specific search space values, not only can the search space be defined without increasing the search options, but also be used to elastically fine-tune the supernet, which now has lower forward and backward pass cost compared to without such a search space definition, due to reduced maximum dimension(s) for some layers. Additionally, because the elastic fine-tuning may be started from a normally pre-trained model (e.g., a foundational model), without incurring any additional elastic pretraining cost and use of a large corpus of pretrained models.

Alternatively, the user may be allowed to define the elastic search space in a heterogeneous way (e.g., via the configuration), instead of defining it via the framework (driven by sensitivity). Such an approach may require additional hardware and/or domain expertise from the user. Nevertheless, examples disclosed herein enable both a sensitivity driven approach and/or a user-defined approach to defining the elastic search space.

Using the search space, the example model trimming circuitry 240 trims the foundational model to achieve a target dimension (e.g., as defined by the elastic search space). (Block 450). In some examples, the trimming of the layer is performed based on the sensitivity of the layer. The example fine-tuning circuitry 250 fine-tunes the trimmed foundational model based on the elastic search space to create a sub-model. (Block 460). In some examples, the fine-tuning of the trimmed foundational model is performed based on the identified sensitivity of the layers of the foundational model, as was explained above in connection with FIG. 3. In this manner, trimmed layers having a sensitivity that meets a threshold sensitivity may be fine-tuned to attempt to enhance the accuracy of the sub-model.

This sub-model is added to a plurality of sub-models by the example elastic search circuitry 260. (Block 470). The example elastic search circuitry 260 determines whether an additional sub-model is to be created within the search space. (Block 480). The determination of whether to proceed with creation of an additional sub-model may be based on the configuration accessed at block 430. For example, the configuration may define an amount of time and/or computing resources that may be utilized to create the plurality of sub-models. If the defined amount of time and/or computing resources has not been met, control may return to block 450, where a subsequent sub-model is created. In some examples, subsequent sub-models are created with varying target dimensions and/or sensitivity thresholds, as defined by the elastic search space.

After determining that no additional sub-models are to be created (e.g., block 480 returns a result of NO), the example elastic search circuitry 260 generates a pareto-optimal representation of the plurality of sub-models. (Block 490). This representation enables the user to better understand the varying parameters that may be used to create a sub-model. An example representation of the sub-models is illustrated by the pareto frontier representation 180 of FIG. 1. The example process 400 of FIG. 4 then terminates, but may be re-executed to perform further sensitivity-based training of a foundational model.

FIG. 5 is a block diagram 500 representing the example trimming process of FIGS. 3 and/or 4. As shown in FIG. 5, for a layer 1, for MHSA, the intermediate dimensions after trimming can be given by D′attn, instead of the original Dattn. In this case, D′attn is less than Dattn (e.g., the original, untrimmed, dimension). Apart from the L1 regularization-based mask learning, other low-cost proxies may be utilized to evaluate the layer sensitivity, including Hessian or gradient driven direct sensitivity evaluation.

FIG. 6 illustrates sensitivities of layers of a machine learning model. A first graph 610 represents sensitivities for head layers of a model. A second graph 620 identifies sensitivities of non-head layers of the model (e.g., MLP layers, MHSA layers). In examples disclosed herein, SST-2 is used as a downstream task to evaluate sensitivity. A third graph 630 illustrates performance vs parameter budget on SQUAD v1.1 with a BERT-base model. As is illustrated in the third graph 630, the model retains close to baseline F1 score and EM even at a smaller budget of 0.3, representing only 30% of the total parameters being non-zero.

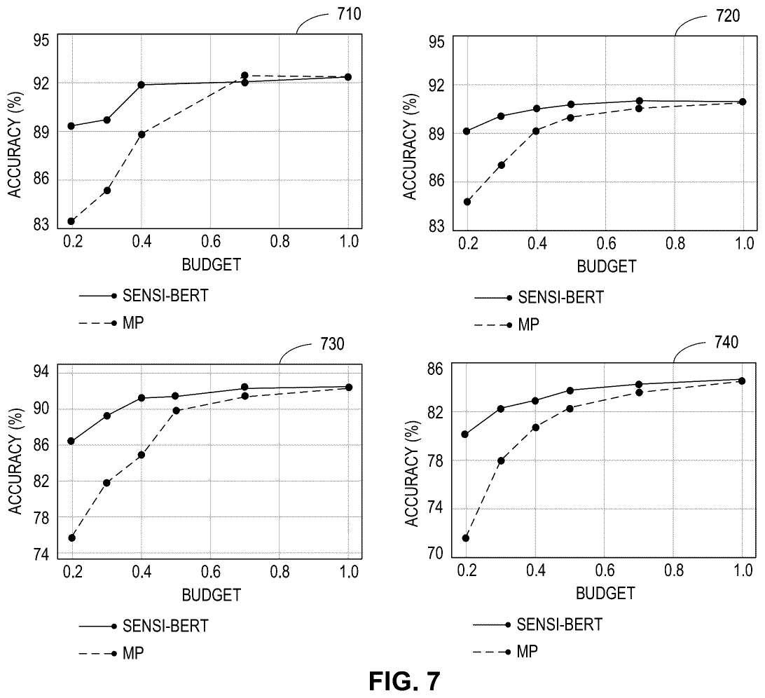

FIG. 7 illustrates accuracy of resultant models based on varying training budgets. FIG. 7 illustrates the efficacy of the example sensitivity driven fine-tuning on four GLUE benchmark datasets in graphs 710, 720, 730, 740. As depicted in graph 630 of FIG. 6 and graphs 710, 720, 730, 740 of FIG. 7, the examples disclosed herein retain close to the baseline performance even at a very low parameter budget of 0.4, meaning only 40% of the total parameters being non-zero. Note that, in both FIG. 6 (the third graph 630) and FIG. 7, the budget of 1.0 represents the full model being updated, while lower the lower budget meaning lower number of parameters being updated to non-zero. FIG. 7 also demonstrates the impact on model performance due to magnitude-driven pruning. In examples disclosed herein, naïve magnitude pruning can cause a significant drop in performance, particularly at lower budgets. Thus, it is hypothesized that naïve magnitude pruning or random indexed driven pruning would suffer from a significant accuracy drop at low parameter budget compared to our approach.

It is noteworthy that the examples disclosed herein remove intermediate layer nodes and associated edges that are incoming to that node based on their sensitivity, which is evaluated in a first (e.g., initial) stage. This is different from irregular or random pruning. As for random pruning, while retaining N edges, N indexes are stored for each edge location. In contrast, examples disclosed herein can afford to keep N/m indices, where m corresponds to the number of edges that are incoming to a node, which is significantly smaller than that of N. Thus, examples disclosed herein present a budget driven parameter reduction, which is orthogonal to the line of research that tries to reduce the quadratic compute complexity of self-attention module. For example, because of the focus on reducing the Dattn (i.e., the intermediate dimension), existing approaches do not help in reducing the complexity of self-attention. However, examples disclosed herein can directly be augmented with the linear attention layers as well, to further reduce their matmul operations.

FIG. 8 is a block diagram of an example programmable circuitry platform 800 structured to execute and/or instantiate the example machine-readable instructions and/or the example operations of FIGS. 3 and/or 4 to implement the sensitivity-based training circuitry 200 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example foundational model accessor circuitry 210, the example configuration accessor circuitry 220, the example sensitivity analyzer circuitry 230, the example model trimming circuitry 240, the example fine-tuning circuitry 250, the example elastic search circuitry 260.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 3 and/or 4, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 3 and/or 4 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine-readable instructions and/or operations represented by the flowcharts of FIGS. 3 and/or 4.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 3 and/or 4 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3 and/or 4. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3 and/or 4. As such, the FPGA circuitry 1000 may be configured and/or structured to effectively instantiate some or all of the operations/functions corresponding to the machine readable instructions of the flowchart(s) of FIGS. 3 and/or 4 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 3 and/or 4 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 3 and/or 4 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 3 and/or 4 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 3 and/or 4, and/or an ASIC may be configured and/or structured to perform third operation(s)/function(s) corresponding to a third portion of the machine readable instructions represented by the flowcharts of FIGS. 3 and/or 4.

It should be understood that some or all of the circuitry of FIG. 2 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

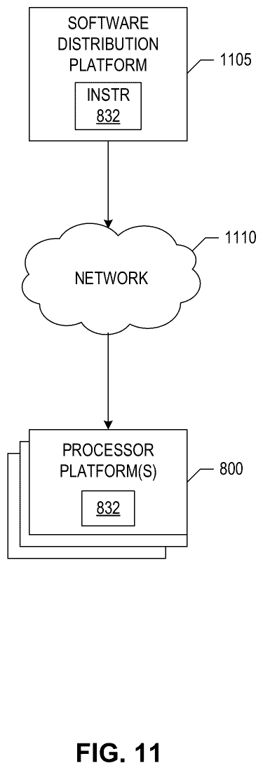

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 3 and/or 4, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 3 and/or 4, may be downloaded to the example programmable circuitry platform 800, which is to execute the machine readable instructions 832 to implement the sensitivity-based training circuitry 200. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture sensitivity-based fine-tuning of a machine learning model are disclosed herein. Further examples and combinations thereof include the following:

Example 1 includes at least one non-transitory machine-readable medium comprising machine-readable instructions to cause at least one processor circuit to at least perform a sensitivity analysis of a foundational model to identify sensitivity scores of respective layers of the foundational model, trim an intermediate layer of the foundational model based on the respective sensitivity score, and fine-tune the trimmed foundational model to create a fine-tuned model, the fine-tuning applied to layers having a respective sensitivity score that meets a threshold sensitivity.

Example 2 includes the at least one non-transitory machine-readable medium of example 1, wherein the foundational model is a large language model (LLM).

Example 3 includes the at least one non-transitory machine-readable medium of example 1, wherein the intermediate layer is trimmed to achieve a target dimension, and the machine-readable instructions are to cause one or more of the at least one processor circuit to determine an elastic search space for creation of a plurality of sub-models, and create the plurality of sub-models based on the elastic search space, the elastic search space defining varying target dimensions for respective ones of the plurality of sub-models.

Example 4 includes the at least one non-transitory machine-readable medium of example 3, wherein the machine-readable instructions are to cause one or more of the at least one processor circuit to generate a pareto-optimal representation of the plurality of sub-models.

Example 5 includes the at least one non-transitory machine-readable medium of example 1, wherein the machine-readable instructions are to cause one or more of the at least one processor circuit to fine-tune the foundational model based on a mask tensor to indicate whether the sensitivity score of the respective layer meets the threshold sensitivity.

Example 6 includes the at least one non-transitory machine-readable medium of example 1, wherein the sensitivity scores represent a relative importance of a layer of the foundational model to an output of the foundational model.

Example 7 includes the at least one non-transitory machine-readable medium of example 6, wherein the sensitivity scores are calculated based on dimensions of the respective layer and weights of the respective layer.

Example 8 includes the at least one non-transitory machine-readable medium of example 1, wherein the threshold sensitivity is computed such that respective layers that are to be fine-tuned result in utilization of a selected compute budget.

Example 9 includes an apparatus comprising interface circuitry, machine-readable instructions, and at least one processor circuit to be programmed by the machine-readable instructions to perform a sensitivity analysis of a foundational model to identify sensitivity scores of respective layers of the foundational model, trim an intermediate layer of the foundational model based on the respective sensitivity score, and fine-tune the trimmed foundational model to create a fine-tuned model, the fine-tuning applied to layers having a respective sensitivity score that meets a threshold sensitivity.

Example 10 includes the apparatus of example 9, wherein the foundational model is a large language model (LLM).

Example 11 includes the apparatus of example 9, wherein the intermediate layer is trimmed to achieve a target dimension, and the at least one processor circuit is to determine an elastic search space for creation of a plurality of sub-models, and create the plurality of sub-models based on the elastic search space, the elastic search space defining varying target dimensions for respective ones of the plurality of sub-models.

Example 12 includes the apparatus of example 11, wherein the at least one processor circuit is to generate a pareto-optimal representation of the plurality of sub-models.

Example 13 includes the apparatus of example 9, wherein one or more of the at least one processor circuit is to fine-tune the foundational model based on a mask tensor to indicate whether the sensitivity score of the respective layer meets the threshold sensitivity.

Example 14 includes the apparatus of example 9, wherein the sensitivity scores represent a relative importance of a layer of the foundational model to an output of the foundational model.

Example 15 includes the apparatus of example 14, wherein the sensitivity scores are calculated based on dimensions of the respective layer and weights of the respective layer.

Example 16 includes the apparatus of example 9, wherein the threshold sensitivity is computed such that respective layers that are to be fine-tuned result in utilization of a selected compute budget.

Example 17 includes a method comprising performing a sensitivity analysis of a foundational model to identify sensitivity scores of respective layers of the foundational model, trimming, by at least one processor circuit programmed by at least one instruction, an intermediate layer of the foundational model based on the respective sensitivity score, and fine-tuning, by one or more of the at least one processor circuit, the trimmed foundational model to create a fine-tuned model, the fine-tuning applied to layers having a respective sensitivity score that meets a threshold sensitivity.

Example 18 includes the method of example 15, further including fine-tuning the foundational model based on a mask tensor to indicate whether the sensitivity score of the respective layer meets the threshold sensitivity.

Example 19 includes the method of example 15, wherein the sensitivity scores represent a relative importance of a layer of the foundational model to an output of the foundational model.

Example 20 includes the method of example 19, wherein the sensitivity scores are calculated based on dimensions of the respective layer and weights of the respective layer.

From the foregoing, it will be appreciated that example systems, apparatus, articles of manufacture, and methods have been disclosed that enable sensitivity based fine-tuning of a machine learning model. Disclosed systems, apparatus, articles of manufacture, and methods improve the efficiency of using a computing device by enabling fine-tuning to be performed in a more time-efficient manner. By performing fine-tuning more efficiently, additional and/or larger models may be trained in a similar amount of time. Moreover, resource utilization of such training is reduced, enabling such fine-tuning to be performed on lower-powered hardware. As a result, fine-tuning may enable end-users to fine-tune on local data sets using local (e.g., lower-powered) compute resources, instead of requiring high-powered compute resources to accomplish fine-tuning. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
perform a sensitivity analysis of a foundational model to identify sensitivity scores of respective layers of the foundational model;
trim an intermediate layer of the foundational model based on the respective sensitivity score; and
fine-tune the trimmed foundational model to create a fine-tuned model, the fine-tuning applied to layers having a respective sensitivity score that meets a threshold sensitivity.

2. The at least one non-transitory machine-readable medium of claim 1, wherein the foundational model is a large language model (LLM).

3. The at least one non-transitory machine-readable medium of claim 1, wherein the intermediate layer is trimmed to achieve a target dimension, and the machine-readable instructions are to cause one or more of the at least one processor circuit to:
determine an elastic search space for creation of a plurality of sub-models; and
create the plurality of sub-models based on the elastic search space, the elastic search space defining varying target dimensions for respective ones of the plurality of sub-models.

4. The at least one non-transitory machine-readable medium of claim 3, wherein the machine-readable instructions are to cause one or more of the at least one processor circuit to generate a pareto-optimal representation of the plurality of sub-models.

5. The at least one non-transitory machine-readable medium of claim 1, wherein the machine-readable instructions are to cause one or more of the at least one processor circuit to fine-tune the foundational model based on a mask tensor to indicate whether the sensitivity score of the respective layer meets the threshold sensitivity.

6. The at least one non-transitory machine-readable medium of claim 1, wherein the sensitivity scores represent a relative importance of a layer of the foundational model to an output of the foundational model.

7. The at least one non-transitory machine-readable medium of claim 6, wherein the sensitivity scores are calculated based on dimensions of the respective layer and weights of the respective layer.

8. The at least one non-transitory machine-readable medium of claim 1, wherein the threshold sensitivity is computed such that respective layers that are to be fine-tuned result in utilization of a selected compute budget.

9. An apparatus comprising:
interface circuitry;
machine-readable instructions; and
at least one processor circuit to be programmed by the machine-readable instructions to:
perform a sensitivity analysis of a foundational model to identify sensitivity scores of respective layers of the foundational model;
trim an intermediate layer of the foundational model based on the respective sensitivity score; and
fine-tune the trimmed foundational model to create a fine-tuned model, the fine-tuning applied to layers having a respective sensitivity score that meets a threshold sensitivity.

10. The apparatus of claim 9, wherein the foundational model is a large language model (LLM).

11. The apparatus of claim 9, wherein the intermediate layer is trimmed to achieve a target dimension, and the at least one processor circuit is to:
determine an elastic search space for creation of a plurality of sub-models; and
create the plurality of sub-models based on the elastic search space, the elastic search space defining varying target dimensions for respective ones of the plurality of sub-models.

12. The apparatus of claim 11, wherein the at least one processor circuit is to generate a pareto-optimal representation of the plurality of sub-models.

13. The apparatus of claim 9, wherein one or more of the at least one processor circuit is to fine-tune the foundational model based on a mask tensor to indicate whether the sensitivity score of the respective layer meets the threshold sensitivity.

14. The apparatus of claim 9, wherein the sensitivity scores represent a relative importance of a layer of the foundational model to an output of the foundational model.

15. The apparatus of claim 14, wherein the sensitivity scores are calculated based on dimensions of the respective layer and weights of the respective layer.

16. The apparatus of claim 9, wherein the threshold sensitivity is computed such that respective layers that are to be fine-tuned result in utilization of a selected compute budget.

17. A method comprising:
performing a sensitivity analysis of a foundational model to identify sensitivity scores of respective layers of the foundational model;
trimming, by at least one processor circuit programmed by at least one instruction, an intermediate layer of the foundational model based on the respective sensitivity score; and
fine-tuning, by one or more of the at least one processor circuit, the trimmed foundational model to create a fine-tuned model, the fine-tuning applied to layers having a respective sensitivity score that meets a threshold sensitivity.

18. The method of claim 15, further including fine-tuning the foundational model based on a mask tensor to indicate whether the sensitivity score of the respective layer meets the threshold sensitivity.

19. The method of claim 15, wherein the sensitivity scores represent a relative importance of a layer of the foundational model to an output of the foundational model.

20. The method of claim 19, wherein the sensitivity scores are calculated based on dimensions of the respective layer and weights of the respective layer.
